(19) United States
(12) Patent Application Publication
(10) Pub. No.: US 2025/0195319 A1
(43) Pub. Date: Jun. 19, 2025

(54) MULTI-AXIS HAPTICS DEVICE

(71) Applicant: V.R.S. Virtual Reality Technology Ltd., Limassol (CY)

(72) Inventor: Richard John Parker, Didcot (GB)

(73) Assignee: V.R.S. Virtual Reality Technology Ltd., Limassol (CY)

(21) Appl. No.: 18/543,322

(22) Filed: Dec. 18, 2023

(51) Int. Cl. A61H 19/00; A61H 23/02

(52) U.S. Cl. CPC A61H 19/00; A61H 23/0263

(57) ABSTRACT

Haptics mechanisms are incorporated into a multi-axis stroker device. The multi-axis stroker device is a haptics device such as a sex toy or vibrator. The stroker device includes an outer body and a moveable head operated by a haptics mechanism. The haptics mechanism is disposed within the outer body of the stroker device and may operate the head by moving the head within a plurality of possible axes of movement. Various examples of haptics mechanisms include a belt-driven mechanism in an H-belt configuration and a grooved sleeve mechanism with a double helix groove configuration.

### FIELD OF TECHNOLOGY

This patent application relates generally to haptics devices such as vibrators and other sex toys, and more specifically to electronically operated vibrators that provide movement in a plurality of movement axes.

### BACKGROUND

Haptics devices such as vibrators provide stimulation to users. Typically, movement or vibration of such devices enhance the stimulation enjoyed by the user. Power and movement control are important for having a positive user experience. Unfortunately, movement of such devices can often be poorly controlled, leading to a less enjoyable user experience.

### SUMMARY

Described herein are vibrator devices as well as techniques for operating the vibrator devices.
Clause 1. A vibrator device, comprising: a housing; and a two-axis haptics mechanism, disposed within the housing, the two-axis haptics mechanism comprising: a base; a ring, coupled to the base, disposed around the base, and configured to move relative to the base; a twist pulley, coupled to the ring; a first motor; a second motor; and a belt coupled to the first motor, the second motor, and the twist pulley, wherein: rotation of the first motor and the second motor in opposite directions causes the ring to translate along a stroke axis relative to the base; and rotation of both the first motor and the second motor in a same direction causes the ring to rotate around the stroke axis relative to the base.
Clause 2. The vibrator device of clause 1, wherein the ring comprises ring gear disposed around at least a portion of a circumference of the ring, and wherein the twist pulley comprises a bevel gear mechanically coupled to the ring gear.
Clause 3. The vibrator device of clause 2, wherein rotation of both the first motor and the second motor in the same direction causes the twist pulley to rotate the ring around the stroke axis via the bevel gear driving the ring gear.
Clause 4. The vibrator device of clause 2, wherein rotation of the first motor and the second motor in opposite directions causes a change in distance between the twist pulley and the first motor in the stroke axis direction.
Clause 5. The vibrator device of clause 4, wherein the twist pulley does not rotate when the first motor and the second motor rotate in opposite directions.
Clause 6. The vibrator device of clause 1, further comprising: a second pulley, coupled to the twist pulley, disposed a substantially fixed distance from the twist pulley, and coupled to the belt.
Clause 7. The vibrator device of clause 6, further comprising: a third pulley, coupled to the base; and a fourth pulley, coupled to the base, wherein the third pulley and/or the fourth pulley are disposed at a distal end, wherein the first motor and/or the second motor are disposed at a second end, and wherein the twist pulley is movably disposed to translate within a first movement range between the distal end and the second end.
Clause 8. The vibrator device of clause 7, wherein the belt is arranged in an H pattern.
Clause 9. The vibrator device of clause 1, wherein translation of the ring the stroke axis causes stroke movement of the housing, and wherein rotation of the ring causes lateral movement of the housing.
Clause 10. The vibrator device of clause 1, further comprising: a communications module configured to communicate with a user device; and a processor, configured to operate the first motor and the second motor based on instructions received by the communications module from the user device.
Clause 11. A vibrator device, comprising: a housing; and a two-axis haptics mechanism, disposed within the housing, the two-axis haptics mechanism comprising: a base, comprising a cylindrical form with form features disposed on an outside of the cylindrical form; a first ring, coupled to the base, disposed around the base, and configured to rotate around the base in conformance with the form features; a second ring, coupled to the base, disposed around the base, and configured to rotate around the base in conformance with the form features, wherein: rotation of the first ring and the second ring in opposite directions causes the base to translate along a stroke axis relative to the first ring and the second ring; and rotation of both the first ring and the second ring in a same direction causes the base, the first ring, and the second ring to rotate around the stroke axis.
Clause 12. The vibrator device of clause 11, wherein the first ring and the second ring are disposed proximate to each other.
Clause 13. The vibrator device of clause 12, wherein the first ring and the second ring contact each other.
Clause 14. The vibrator device of clause 12, wherein the first ring and the second ring are configured to rotate while being disposed proximate to each other.
Clause 15. The vibrator device of clause 11, further comprising: a first motor, coupled to the first ring and configured to drive the first ring to rotate around the base; and a second motor, coupled to the second ring and configured to drive the second ring to rotate around the base.
Clause 16. The vibrator device of clause 11, wherein the form features are one or more grooves disposed within the cylindrical form.
Clause 17. The vibrator device of clause 16, wherein the first ring and the second ring both comprise one or more tongues configured to be disposed within the one or more grooves.
Clause 18. The vibrator device of clause 16, wherein the grooves comprise a first helix form disposed on a first side of the cylindrical form and a second helix form disposed on a second side of the cylindrical form.
Clause 19. The vibrator device of clause 11, wherein translation of the base along the stroke axis causes stroke movement of the housing, and wherein rotation of the base, the first ring, and the second ring causes lateral movement of the housing.
Clause 20. The vibrator device of clause 11, further comprising: a communications module configured to communicate with a user device; and a processor, configured to operate the first ring and the second ring based on instructions received by the communications module from the user device.

These and other embodiments are described further below with reference to the figures.

### BRIEF DESCRIPTION OF THE DRAWINGS

The included drawings are for illustrative purposes and serve only to provide examples of possible structures and operations for the disclosed inventive systems, apparatus, methods, and computer program products for haptics devices. These drawings in no way limit any changes in form and detail that may be made by one skilled in the art without departing from the spirit and scope of the disclosed implementations.

FIG. 1 illustrates a perspective view of a haptics device, in accordance with certain embodiments.

FIG. 2 illustrates a top view of a haptics device, in accordance with certain embodiments.

FIG. 3 illustrates a top view of a further haptics device, in accordance with certain embodiments.

FIG. 4 illustrates a perspective view of a haptics mechanism of a haptics device, in accordance with certain embodiments.

FIGS. 5A and 5B illustrate operation of the haptics mechanism of FIG. 4, in accordance with certain embodiments.

FIG. 6 illustrates a side view of another haptics mechanism of a haptics device, in accordance with certain embodiments.

FIGS. 7A and 7B illustrate operation of the haptics mechanism of FIG. 6, in accordance with certain embodiments.

FIG. 8 is a block diagram of a haptics system, in accordance with certain embodiments.

FIG. 9 is a flowchart detailing operation of a haptics system, in accordance with certain embodiments.

FIG. 10 is a block diagram of a computing system, in accordance with certain embodiments.

### DETAILED DESCRIPTION

Described herein are haptics devices, including sex toys such as vibrators. The haptics devices may be communicatively coupled to electronic devices (e.g., user devices and/or server devices) and operated according to data communicated from the electronic devices. In various embodiments, the haptics devices may include haptics mechanisms to move at least a portion of the devices in a plurality of movement axes. Various haptics mechanisms are described herein.

In various embodiments, the haptics mechanisms may be, for example, a multi-axis stroker device. The stroker device may include an outer body and a moveable head operated by a haptics mechanism. The haptics mechanism may be disposed within the outer body of the stroker device and may operate the head by moving the head within a plurality of possible axes of movement.

In certain embodiments, such haptics mechanisms may include a belt-driven mechanism or a grooved sleeve mechanism. The belt-driven mechanism may include, for example, an “H-belt” configuration that includes a moveable pulley. The grooved sleeve mechanism may include a “double helix” groove configuration disposed on the outside of a cylinder.

The haptics mechanisms described herein may allow for greater control of the moveable head of the multi-axis stroker device as stroke and rotation are independent of each other. That is, stroke of the moveable head will not result in rotation and rotation of the moveable head will not result in stroke. Additionally, the haptics mechanisms can provide for quieter operation as the motors will typically rotate more slowly than in a ball screw configuration. The haptics mechanisms may also be more compact than conventional techniques, allowing for tighter packaging for a multi-axis stroker device.

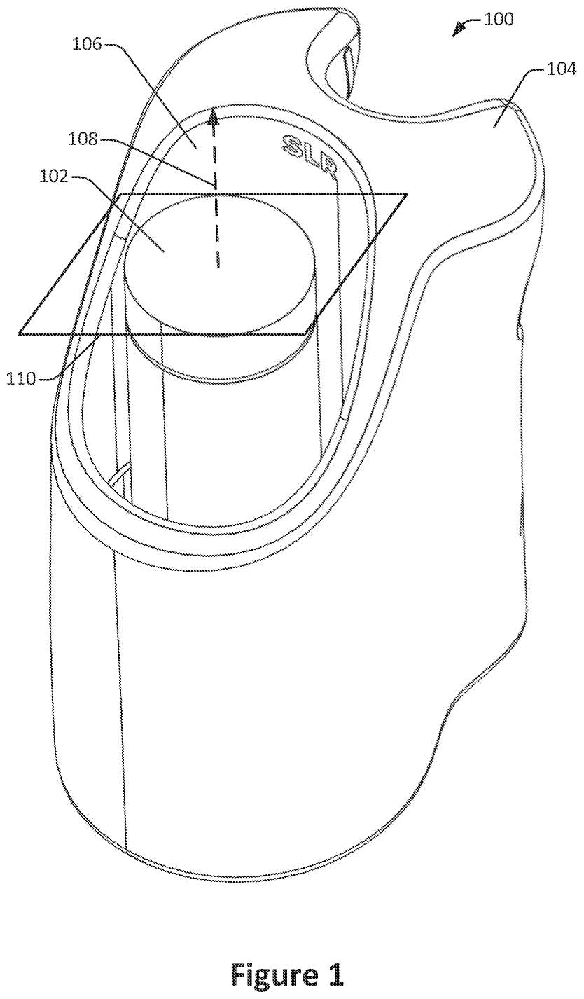

FIG. 1 illustrates a perspective view of a haptics device, in accordance with certain embodiments. FIG. 1 illustrates haptics device 100 that includes moveable head 102, and base 104. In certain embodiments, haptics device 100 may be a part of a system where media is provided to a user (e.g., a media device may provide playback of a media) and haptics device 100 simulates the feeling that a user would receive if the user was a part of the video. Thus, for example, a media device and/or a server media may provide audio and/or video to a user and haptics device 100 may be synchronized with the audio and/or video data provided to simulate the haptics from the video.

Base 104 of haptics device 100 may include a chassis for mounting of various components (e.g., haptics mechanisms described herein) of haptics device 100 and a housing. The chassis and/or housing may be made of one or more of any appropriate material, such as metal, plastic, composites, natural materials such as wood, rubber, foam, and/or another such material. Base 104 may be configured to house various components of haptics device 100 inside of base 104. Thus, for example, base 104 may be configured to house portions of haptics mechanisms described herein.

Base 104 may be coupled to moveable head 102. Moveable head 102 may be configured to move relative to base 104. In various embodiments, base 104 may provide a fixture that haptics mechanism may be coupled to (e.g., may house a chassis). That is, portions of the haptics mechanism may be coupled to base 104 in a substantially fixed relationship. That is, the distance between such portions and base 104 may not significantly change, e.g., the distance may not change for more than 1-2 centimeters during operation of haptics device 100 and, in certain embodiments, may only dimensionally vary due to mechanical stress and/or vibration of haptics device 100 and not due to any design configurations.

Meanwhile, such haptics mechanism may allow for moveable head 102 of haptics device 100 to move relative to base 104. Moveable head 102 may be disposed within cavity 106 of base 104. Cavity 106 may be a cavity within base 104 shaped to accommodate translation and/or rotation of base 104 without moveable head 102 contacting base 104.

In various embodiments, moveable head 102 of haptics device 100 may be configured to move along a plurality of different axes and/or planes. For example, moveable head 102 may translate along stroke axis 108 and rotate (e.g., wobble) and/or twist within plane 110. The axis of such rotation may be stroke axis 108. Thus, the haptics mechanism may allow moveable head 102 to translate along stroke axis 108 and/or rotate within plane 110 relative to base 104.

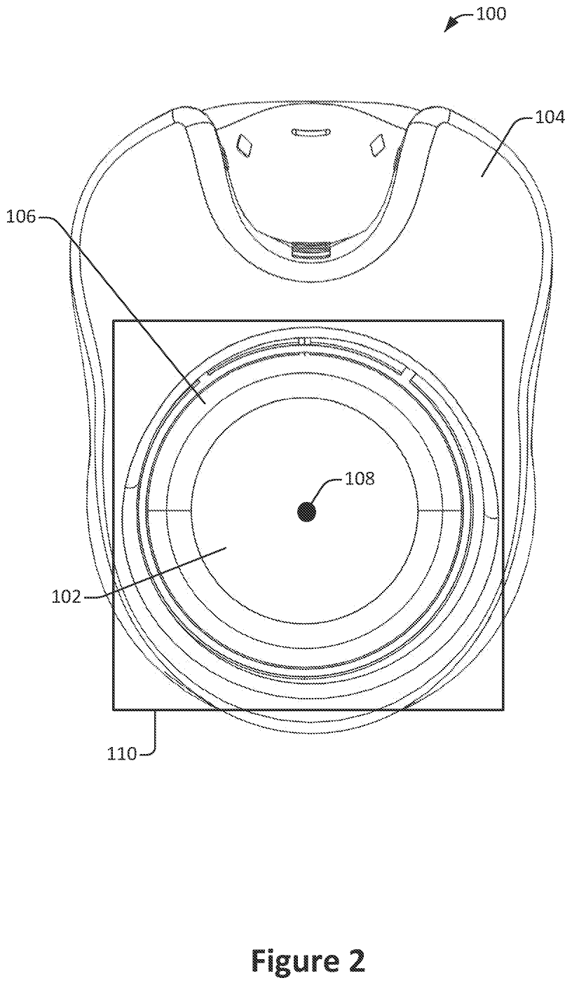

FIG. 2 illustrates a top view of a haptics device, in accordance with certain embodiments. The top view of FIG. 2 illustrates that moveable head 102 is disposed within cavity 106 of base 104 and that cavity 106 includes space for moveable head 102 to rotate within cavity 106 without contacting base 104.

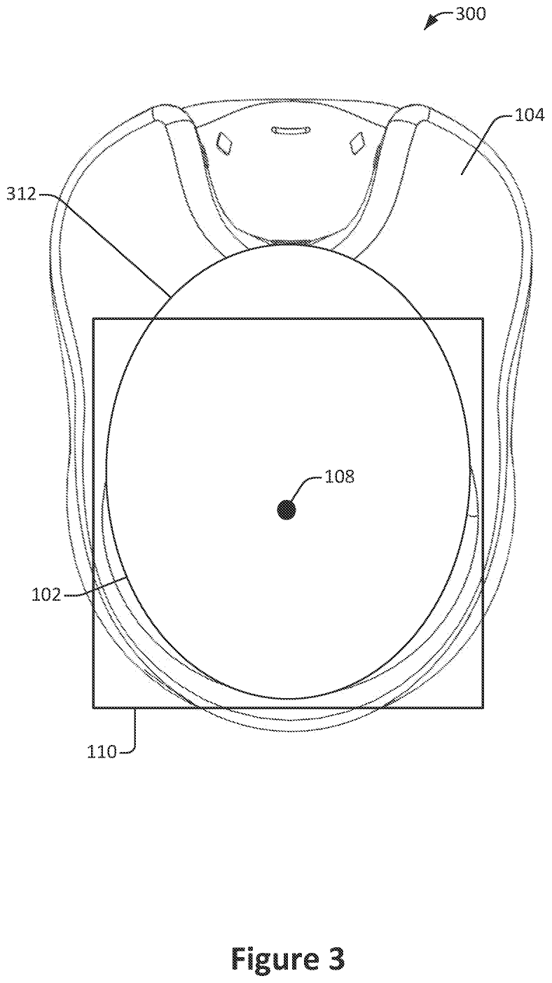

FIG. 3 illustrates a top view of a further haptics device, in accordance with certain embodiments. FIG. 3 illustrates haptics device 300 that includes base 104 and moveable head 102. As shown in FIG. 3, head attachment 312 is coupled to moveable head 102. In various embodiments, head attachment 312 may be, for example, an attachment (e.g., a dildo or penis shaped attachment) that couples to moveable head 102 (e.g., mechanically couples, adhesively couples, and/or couples in another manner that allows for head attachment 312 to be securely attached to moveable head 102). Head attachment 312 may be permanently or removably attached to moveable head 102.

Such coupling may secure head attachment 312 to moveable head 102 such that head attachment 312 translates and/or rotates along with moveable head 102. That is, translation or rotation of moveable head 102 may result in substantially the same translation or rotation, respectively, (e.g., the same amount of translation or rotation minus mechanical deformation) of head attachment 312. Thus, movement of moveable head 102 may be imparted to head attachment 312. As such, the haptics mechanisms described herein may cause movement of head attachment 312 via moveable head 102.

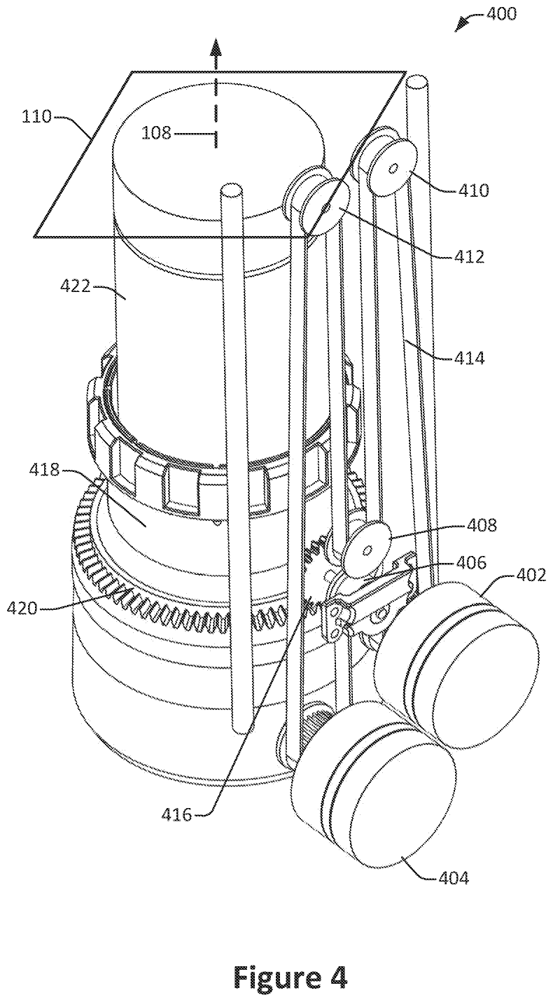

FIG. 4 illustrates a perspective view of a haptics mechanism of a haptics device, in accordance with certain embodiments. FIG. 4 illustrates haptics mechanism 400 that includes drive unit 402, drive unit 404, twist pulley 406, pulley 408, pulley 410, pulley 412, belt 414, gear 416, attachment 418, gear 420, and head 422. Haptics mechanism 400 may be configured to move head 422 along a plurality of different axes, such as translating along stroke axis 108 and/or rotating within plane 110.

Drive unit 402 and drive unit 404 may be drive units such as electric motors and/or actuators configured to move belt 414 (e.g., may provide rotational drive to belt 414 to convey torque or power to, for example, twist pulley 406). For example, drive unit 402 and/or drive unit 404 may be electric motors that drive (e.g., rotate) gears or pulleys. The gears or pulleys may be coupled to belt 414 to convey drive torque to belt 414.

Due to the positioning of drive units and pulleys, belt 414 may be arranged in an “H” configuration. Pulley 410 and pulley 412 may be disposed on one end of the “H” and drive unit 402 and drive unit 404 may be at another end of the “H.” Belt 414 may be coupled to gears and/or pulleys of drive unit 402 and drive unit 404 as well as twist pulley 406, pulley 408, pulley 410, and pulley 412. In various embodiments, drive unit 402, drive unit 404, pulley 410, and pulley 412 may be fixed in distance to a base of the haptics device (e.g., base 104) or another portion of the haptics device. Variously, pulley 408, pulley 410, and/or pulley 412 may include gears (e.g., toothed cylinders) and/or pulleys (e.g., smooth cylinders) for coupling to belt 414.

Twist pulley 406 and pulley 408 may be pulleys configured to move relative to drive unit 402, drive unit 404, pulley 410, and/or pulley 412. In various embodiments, twist pulley 406 and pulley 408 are coupled together so that they move (e.g., translate) together in the same direction (e.g., upward or downward along stroke axis 108). Twist pulley 406 and pulley 408 may be coupled together through one or more of a rigid connection (e.g., a metal, composite, or plastic bar or other such component), a semi-rigid connection (e.g., a string, a cable, or other component that may only be rigid in certain force directions). Accordingly, the distance between twist pulley 406 and pulley 408 may be substantially fixed (e.g., so that the distance between twist pulley 406 and pulley 408 may not vary by more than 25% and such variations may be due to structural flex of the connection of twist pulley 406 and pulley 408. Twist pulley 406 and pulley 408 may not be directly coupled to the base of the haptics device and, thus, may move relative to the base. Thus, based on the direction of rotation of drive unit 402 and/or drive unit 404 (e.g., whether rotating in the same direction or in different directions), movement of belt 414 may rotate twist pulley 406 or a portion thereof (e.g., a toothed cylinder, smooth cylinder, or gear) and/or translate twist pulley 406 and pulley 408, which are coupled together as a pulley assembly.

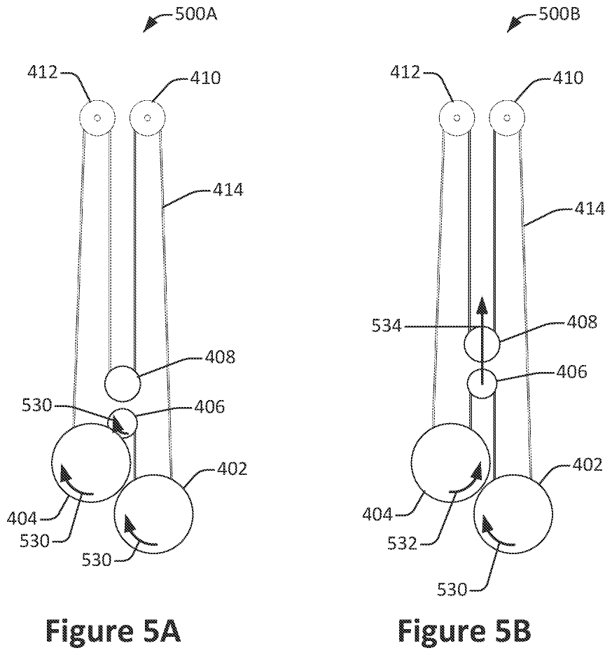

In certain embodiments, translation of twist pulley 406, due to rotation of drive unit 402 and drive unit 404 in different directions as described in FIG. 5B, may result in twist pulley 406 causing attachment 418 to translate along stroke axis 108. In various embodiments, twist pulley 406 may include a gear such as a bevel gear. The gear may be coupled to gear 420, which may be a ring gear disposed around at least a portion of attachment 418. Rotation of gear 420 may cause attachment 418 to rotate and, thus, result in rotation of head 422, which may be coupled to and result in rotation of a head attachment, such as head attachment 312. Accordingly, rotation of twist pulley 406 (or a cylinder or gear thereof) through operation of drive unit 402 and drive unit 404 may result in the rotation of attachment 418 according to rotation of gear 420, causing head 422 to rotate and, thus, causing the rotation of a head attachment such as head attachment 312.

Thus, based on operation of drive unit 402 and drive unit 404, twist pulley 406 may be operated to independently translate or rotate attachment 418. Such operation of drive unit 402 and drive unit 404 may be further described herein and may be due to, for example, how belt 414 is divided based on where the motors and pulleys are disposed within haptics mechanism 400.

Belt 414 may be divided into two portions. The first portion of belt 414 may be the span of belt 414 between drive unit 402 and drive unit 404 that contacts pulley 408, pulley 410, and pulley 412. The first portion may be considered as the upper portion of the “H” of H-shaped belt 414. The second portion of belt 414 may be the span of belt 414 between drive unit 402 and drive unit 404 that contacts twist pulley 406. The second portion may be considered as the lower portion of the “H” of H-shaped belt 414.

FIGS. 5A and 5B illustrate operation of the haptics mechanism of FIG. 4, in accordance with certain embodiments. FIGS. 5A and 5B illustrate how operation of drive unit 402 and drive unit 404 causes movement of twist pulley 406 and/or pulley 408 (and, thus, movement of attachment 418 and head 422 via gear 420). While the examples of FIGS. 5A and 5B describe operation that results in independent translation and rotation of head 422 (e.g., only translation or only rotation), it is appreciated that haptics mechanism 400 may be operated in a manner that provides for both translation and rotation of head 422 at the same time by, for example, operating drive unit 402 and drive unit 404 at different speeds (e.g., by operating drive unit 402 and drive unit 404 at speed different from each other).

In FIG. 5A, example 500A illustrates drive unit 402 and drive unit 404 rotating in the same rotational angular direction 530 (e.g., in the clockwise direction). When drive unit 402 and drive unit 404 rotate in the same direction, belt 414 is driven in a manner where the first and second portions of belt 414 remain the same or substantially the same in terms of length, causing rotation of twist pulley 406 in the same angular direction 530. Conversely, when drive unit 402 and drive unit 404 both rotate in the angular direction opposite that of angular direction 530 (e.g., counterclockwise), twist pulley 406 rotates in that direction (e.g., counterclockwise) as well. Rotation of twist pulley 406 and, thus, gear 420 may cause attachment 418 and head 422 to rotate accordingly.

In FIG. 5B, example 500B illustrates drive unit 402 and drive unit 404 rotating in opposite angular directions: angular direction 530 and angular direction 532, respectively. Rotation of drive unit 402 and drive unit 404 in opposite directions causes belt 414 to translate twist pulley 406 along translational direction 534. For example, in the example of FIG. 5B, rotation of drive unit 402 in angular direction 530 and drive unit 404 in angular direction 532 may increase the length of the span of the second portion of belt 414 (e.g., the lower portion) and decrease the length of the span of the first portion of belt 414 (e.g., the upper portion), causing twist pulley 406 and pulley 408, which is coupled to twist pulley 406, to translate upward (e.g., in translational direction 534) along stroke axis 108. Conversely, in another example, rotation of drive unit 402 in angular direction 532 and drive unit 404 in angular direction 530 may decrease the length of the span of the second portion of belt 414 (e.g., the lower portion) and increase the length of the span of the first portion of belt 414 (e.g., the upper portion), causing twist pulley 406 and pulley 408 to translate downward (e.g., opposite of that translational direction 534) along stroke axis 108. Translation of twist pulley 406 and pulley 408 may cause head 422 and, therefore, any head attachment coupled to head 422 to translate accordingly.

Accordingly, as described in FIGS. 4, 5A, and 5B, the configuration of haptics mechanism 400 may result in multi-axis movement, such as translation and rotation, of a head (e.g., head 422) and head attachment (e.g., a dildo shaped attachment) of a haptics mechanism. Variously, such translation and rotation may be independent of each other (e.g., drive unit 402 and drive unit 404 cannot both rotate in the same direction and rotate in opposite directions at the same time). As movement is independent of each other, drive unit 402 and drive unit 404 may be operated to provide significant power.

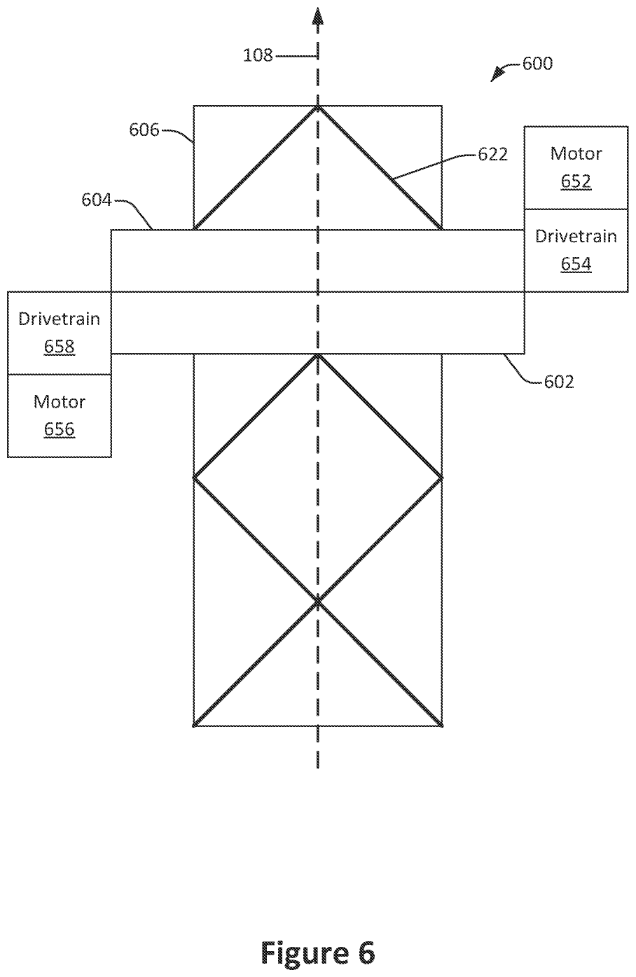

FIG. 6 illustrates a side view of another haptics mechanism of a haptics device, in accordance with certain embodiments. FIG. 6 illustrates haptics mechanism 600 which may include ring 602 and ring 604 disposed around cylindrical form 606.

Cylindrical form 606 may be equivalent to, for example, attachment 418 of haptics mechanism 400. Thus, cylindrical form 606 may be coupled to or form a portion of a head of a haptics device. A head attachment may be accordingly coupled to cylindrical form 606. Cylindrical form 606 may cause movement of the head attachment according to the techniques described herein.

Cylindrical form 606 may include form features, such as grooves 622, disposed on an outer surface of the cylinder, such as along the height of cylindrical form 606. Ring 602 and ring 604 may be disposed on the outer portion of cylindrical form 606, such as the portion of cylindrical form 606 that includes ring 602. Grooves 622 may be configured to guide movement of ring 602 and/or ring 604 along the surface of cylindrical form 606. In various embodiments, grooves 622 may be, for example, one or more double helix grooves. A single double helix groove is illustrated in FIG. 6, but it is appreciated that, in certain such embodiments, a one or more corresponding double helix grooves may be disposed on other portions of cylindrical form 606, such as another corresponding double helix groove an opposite side of cylindrical form 606.

Ring 602 and ring 604 may include features configured to interface with the form features (e.g., grooves 622) of cylindrical form 606. In certain embodiments, the features of ring 602 and ring 604 may be, for example, tongues, rollers, slides, bearings, and/or other such features configured to be disposed within grooves 622 and allow movement of ring 602 and/or ring 604 guided by grooves 622. As shown, the double helix grooves of grooves 622 may include two “strands” and the feature(s) of ring 602 configured to interface with grooves 622 may be disposed within one of the “strands” and the feature(s) of ring 604 configured to interface with grooves 622 may be disposed within the other of the “strands.”

Ring 602 may be driven by motor 656. Thus, motor 656 may drive ring 602 to rotate around stroke axis 108. Motor 656 may be any type of suitable motor, such as electric motors or actuators, hand driven mechanisms, piezoelectric devices, and/or other such motors that are configured to provide drive torque (e.g., rotational torque). In various embodiments, the drive torque from motor 656 may be transmitted to ring 602 via drivetrain 658. Drivetrain 658 may be any suitable drivetrain, such as single or multi-speed gear, belt, chain, or other types of drives.

Similarly, ring 604 may be driven by motor 652 to rotate ring 604 around stroke axis 108. In various embodiments, motor 652 may drive ring 604 via drivetrain 654. Motor 652 and drivetrain 654 may be any type of motor and/or drivetrain described herein.

In various embodiments, the inside and outside of ring 602 and/or ring 604 may be cylindrical or may be of another geometry. The inside geometry of ring 602 and/or ring 604, if not cylindrical, may nonetheless include appropriately shaped forms to interface with grooves 622. In certain embodiments, ring 602 and ring 604 may be configured to disposed proximate to each other. In certain such embodiments, ring 602 and ring 604 may be operated in a manner where the distance between ring 602 and ring 604 is substantially fixed (e.g., within a distance of 1 cm) and/or are in contact with each other.

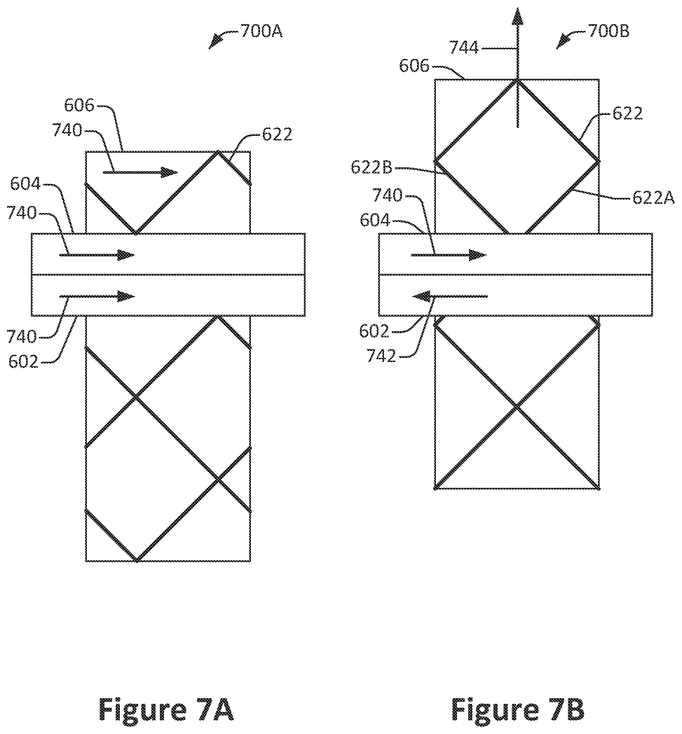

FIGS. 7A and 7B illustrate operation of the haptics mechanism of FIG. 6, in accordance with certain embodiments. FIGS. 7A and 7B illustrate how rotation of ring 602 and ring 604 causes movement of cylindrical form 606. Such movement of cylindrical form 606 may be due to the interfacing of grooves 622 with features of ring 602 and ring 604.

In FIG. 7A, example 700A illustrates ring 602 and ring 604 rotating in the same rotational angular direction 740. In various embodiments, angular direction 740 may be, for example, a clockwise or counterclockwise direction. Rotation of ring 602 and ring 604 in the same direction may cause cylindrical form 606 to also rotate in the same direction (e.g., angular direction 740). Accordingly, any attachment coupled to cylindrical form 606 (e.g., head attachment 312), may also accordingly rotate in the same direction. While the examples of FIGS. 7A and 7B describe operation that results in independent translation and rotation of cylindrical form 606 (e.g., only translation or only rotation), it is appreciated that haptics mechanism 600 may be operated in a manner that provides for both translation and rotation of cylindrical form 606 at the same time by, for example, operating drive unit motor 652 and drivetrain 654 at different speeds.

In FIG. 7B, example 700B illustrates ring 602 and ring 604 rotating in opposite angular directions 742 and 740, respectively. As the distance between ring 602 and ring 604 may be substantially fixed and/or ring 602 and ring 604 may be in contact with each other during operation, rotation of ring 602 and ring 604 in opposite directions may cause cylindrical form 606 to translate in translational direction 744 or the opposite direction, depending on the configuration of grooves 622 and the features of ring 602 and ring 604. Accordingly, depending on which of the two “strands” of the double helix grooves 622 each of ring 602 and ring 604 are configured to interface, rotation of ring 602 and ring 604 in opposite angular directions 742 and 740, respectively, may cause cylindrical form 606 to translate in translational direction 744 or the opposite direction.

For example, ring 602 may include features configured to interface with groove 622A and ring 604 may include features configured to interface with groove 622B. Rotation of ring 602 in angular direction 742 may cause such features of ring 602 to apply force to the upper ledge of groove 622A while rotation of ring 604 in angular direction 740 may cause such features of ring 604 to apply force to the upper ledge of groove 622B. Such force may, due to the angle that grooves 622A and 622B are disposed at, generate an upward force vector on cylindrical form 606 and cause cylindrical form 606 to move in translational direction 744. Alternatively, both ring 602 and ring 604 may move in directions opposite that of angular direction 742 and angular direction 740, respectively, and apply force to the lower ledges of grooves 622A and 622B, resulting in a downward force vector on cylindrical form 606 and cause cylindrical form 606 to move downward (e.g., in the direction opposite that of translational direction 744).

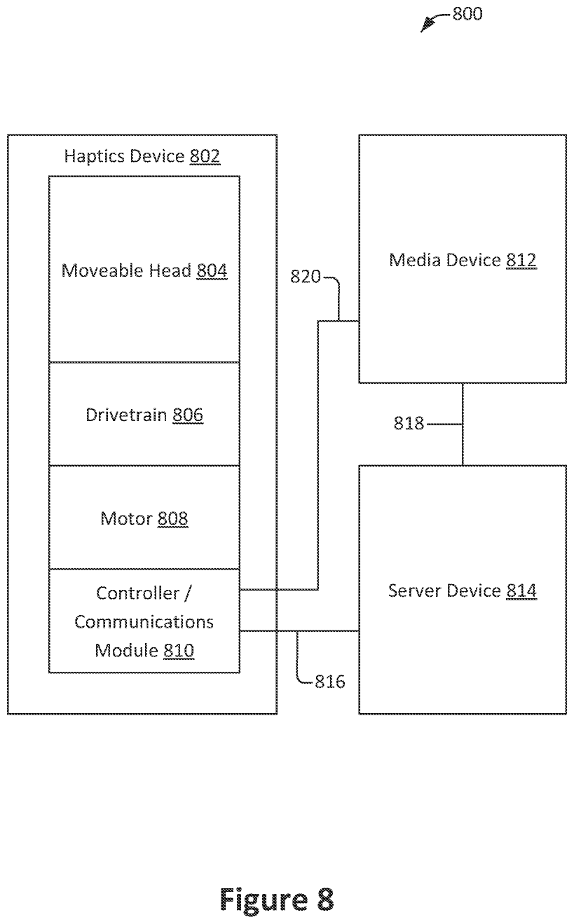

FIG. 8 is a block diagram of a haptics system, in accordance with certain embodiments. FIG. 8 illustrates system 800, which may include haptics device 802, media device 812, and server device 814. Haptics device 802, media device 812, and server device 814 may be communicatively coupled via communications channel 816 (for haptics device 802 and server device 814), communications channel 818 (for server device 814 and media device 812), and communications channel 820 (for haptics device 802 and media device 812). Such communications channels may be any wired or wireless communications connection that allows for data to be sent, such as a wired Ethernet connection or a wireless connection such as WiFi, 3G, 4G, 5G, or another such connection that allows for data to be transmitted. In various embodiments, the various components of the systems described herein may utilize one, some, or all of such data connections to communicate and/or receive data.

Haptics device 802 may be a haptics device as described herein, such as haptics device 100. Haptics device 802 may include motor 808, drivetrain 806, moveable head 804, and controller/communications module 810. Motor 808, drivetrain 806, and moveable head 804 may be similar to such items described herein. Controller/communications module 810 may include a controller (e.g., processor and memory) for operating haptics device 802 as well as a communications module for providing and receiving data from other devices, such as media device 812 and server device 814. Such data may be used to operate motor 808 and, thus, operate moveable head 804 through the movement of motor 808. In various embodiments, the controller and the communications module may be integrated (e.g., disposed on the same PCB board) and/or may be separate modules (e.g., separate components or utilizing separate PCB boards).

Media device 812 may be, for example, a user device that is configured to provide media (e.g., video or audio media) to a user. Thus, media device 812 may include a display as well as a processor and memory. Media device 812 may provide data to haptics device 802 to synchronize operation of haptics device 802 to the media provided by media device 812. Thus, for example, media device 812 may provide data that operations operation of the various motors of haptics device 802 to, for example, provide movement between various axes.

In certain embodiments, media device 812 may communicate such operational instructions as data to haptics device 802, in order to allow for movement of haptics device 802 to be synchronized to the media played on media device 812 (e.g., to allow for optimized timing). Certain such embodiments may include media device 812 first receiving such instructions from server device 814 (e.g., via communications channel 818), while other embodiments may include instructions that are, additionally or alternatively, determined by media device 812 through other techniques (e.g., via instructions received from another source or determined by a user operating media device 812).

Server device 814 may be any type of server that may receive or provide data from portions of system 800. Server device 814 may be, for example, a server rack or computer that may store data (e.g., videos and the associated metadata, such as associated instructions for operation of a haptics device).

Server device 814 may determine the type of haptics device (e.g., determine that it is a multi-axis haptics device) via device data communicated via communications channel 816 from haptics device 802. Based on such a determination, server device 814 may select the appropriate operating instructions for operation of haptics device 802. Thus, for example, for the same piece of media (e.g., same video), server device 814 may include instructions for operating a single axis haptic device and for operating a multi-axis haptic device. Based on the type of haptics device determined, the appropriate set of instructions for operating haptics device 802, according to the selected media, may be determined. In certain embodiments, such instructions may be similar to a “script” for operation of the haptics device, in a manner that is synchronized with the video to provide haptic feel to a viewer of the media.

In various embodiments, server device 814 may provide data including operational instructions to haptics device 802, additional or alternative to media device 812 providing such data. Haptics device 802 may receive such data via controller/communications module 810. Haptics device 802 may also include a controller that, upon receiving the data with the instructions may cause various components of haptics device 802, such as motor 808, to operate according to the instructions.

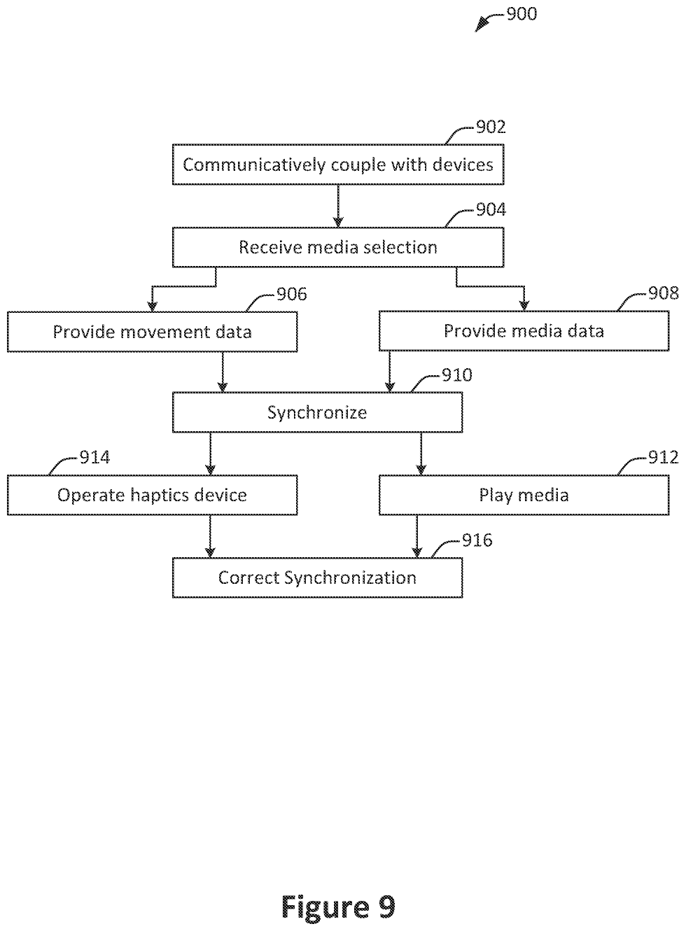

FIG. 9 is a flowchart detailing operation of a haptics system, in accordance with certain embodiments. FIG. 9 is a flowchart detailing technique 900. Technique 900 may be for operation of a haptics device as described herein.

In 902, the haptics device may communicatively couple with other devices, such as a user device (e.g., media device) and/or a server device. Communicative coupling may include establishing a data connection via wired or wireless data connections, such as long ranged wireless data connections (e.g., WiFi, 4G, 5G, etc.) or short ranged wireless data connections (e.g., Bluetooth). After the haptics device has communicatively coupled with the devices, a media selection may be received from a user in 904. The media selection may be, for example, a selection of a video for playback on the media device. The selection may be made on the media device or through another such device (e.g., another user device communicatively coupled to the media device and/or the haptics device). The server device may receive the media selection from such a device.

Based on the media selection, movement data (e.g., for operation of the haptics device) and media data (e.g., video and/or audio data for playback on the media device) may be provided by the server device in 906 and 908, respectively. In various embodiments, the movement data and/or the media data may be provided, variously, to the media device and/or the haptics device. Thus, the movement data and the media data may first be provided to the media device, the movement data may be provided to the haptics device and the media data provided to the media device, or the movement data and the media data may be first provided to the haptics device.

The haptics device and the media device may be synchronized in 910. Accordingly, the media device and the haptics device may both be operated according to, for example, the test data, in order to fully synchronize the devices. For example, in certain embodiments, the media device may provide operational data that includes the test data to the haptics device. A test may be conducted to determine the latency between the media system and the haptics system, where the media device may transmit the test data to both the server device and the haptics device. The haptics device may then receive the data and provide the data to the server device. Based on the difference in time from when the data was received from the haptics device and the media device, the server device may determine the latency between the media device and the haptics device. Such latency may be communicated to the media device and the media device may adjust the timing of its media playback and that of its communication of data to the haptics device accordingly.

After such a determination, and upon receipt of the appropriate data (according to the techniques described herein), the media device may provide playback of the media, in 912, and the haptics device may be operated to provide stimulation to a user based on the media that is playing, in 914. The haptics device may be variously operated to provide movement along multiple axes, in accordance with the techniques described herein. Thus, the haptics device may be operated to provide both thrust and rotation, independently of each other.

In another embodiment, alternative or additional to synchronization performed in 910, synchronization of the haptics device and the media device may be corrected during operation, in 916. The haptics device and the media device may both communicate time stamp data of the media that is playing, for the media device, and the time data of the stimulation “script” that the haptics device is providing, for the haptics device, to the server device. Based on the time stamp data received, the server device may synchronize the playback of the media on the media device and the operation of the haptics device (e.g., so that the haptics device is providing stimulation that is synchronized with the media being played by the media device). Thus, if the server device determines that there is a mismatch between the media played by the media device and the stimulation provided by the haptics device, the server device may provide a new timestamp to the haptics device, causing the haptics device to advance or retard within the stream and, thus, synchronizing the media device and the haptics device.

As such, the techniques described herein allow for operation of a haptics device that can provide independent movement in a plurality of different axes in a manner that provides for greater power and enjoyment.

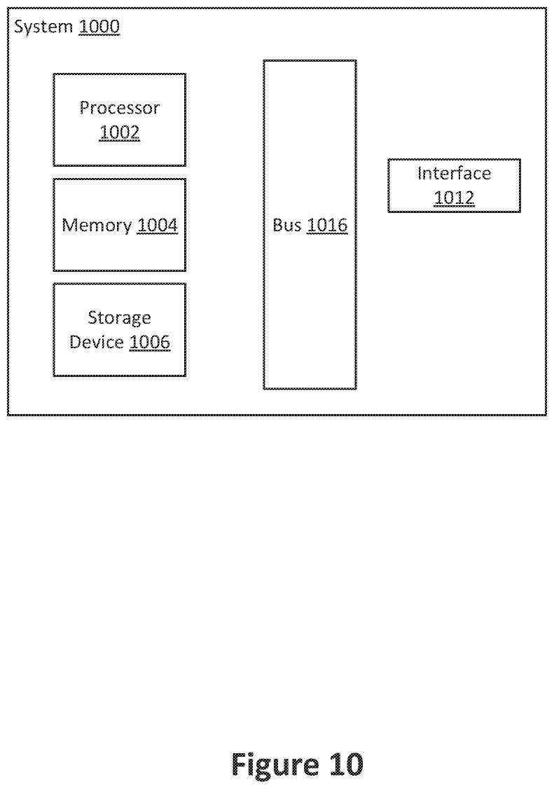

FIG. 10 is a block diagram of a computing system, in accordance with certain embodiments. According to various embodiments, a system 1000 suitable for implementing embodiments described herein includes a processor 1002, a memory module 1004, a storage device 1006, an interface 1012, and a bus 1016 (e.g., a PCI bus or other interconnection fabric.) System 1000 may operate as variety of devices such as a haptics device, a server device, a user device, a media device, and/or an application server. Such devices or servers may be electronic devices such as a haptics device (e.g., electronic dildo), a laptop, desktop, smartphone, tablet, wearable device, or any other device or service described herein.

Although a particular configuration is described, a variety of alternative configurations are possible. The processor 1002 may perform operations such as those described herein. Instructions for performing such operations may be embodied in the memory 1004, on one or more non-transitory computer readable media, or on some other storage device. Various specially configured devices can also be used in place of or in addition to the processor 1002. The interface 1012 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

### CONCLUSION

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various implementations have been described herein, it should be understood that they have been presented by way of example only, and not limitation. For example, some techniques and mechanisms are described herein in the context of vibrators. However, the techniques of the present invention apply to a wide variety of haptics devices. Particular embodiments may be implemented without some or all of the specific details described herein. In other instances, well known process operations have not been described in detail in order not to unnecessarily obscure the present invention. Accordingly, the breadth and scope of the present application should not be limited by any of the implementations described herein, but should be defined only in accordance with the claims and their equivalents.

1. A vibrator device, comprising:
a housing; and
a two-axis haptics mechanism, disposed within the housing, the two-axis haptics mechanism comprising:
a base;
a ring, coupled to the base, disposed around the base, and configured to move relative to the base;
a twist pulley, coupled to the ring;
a first motor;
a second motor; and
a belt coupled to the first motor, the second motor, and the twist pulley, wherein:
rotation of the first motor and the second motor in opposite directions causes the ring to translate along a stroke axis relative to the base; and
rotation of both the first motor and the second motor in a same direction causes the ring to rotate around the stroke axis relative to the base.

2. The vibrator device of claim 1, wherein the ring comprises ring gear disposed around at least a portion of a circumference of the ring, and wherein the twist pulley comprises a bevel gear mechanically coupled to the ring gear.

3. The vibrator device of claim 2, wherein rotation of both the first motor and the second motor in the same direction causes the twist pulley to rotate the ring around the stroke axis via the bevel gear driving the ring gear.

4. The vibrator device of claim 2, wherein rotation of the first motor and the second motor in opposite directions causes a change in distance between the twist pulley and the first motor in the stroke axis direction.

5. The vibrator device of claim 4, wherein the twist pulley does not rotate when the first motor and the second motor rotate in opposite directions.

6. The vibrator device of claim 1, further comprising:
a second pulley, coupled to the twist pulley, disposed a substantially fixed distance from the twist pulley, and coupled to the belt.

7. The vibrator device of claim 6, further comprising:
a third pulley, coupled to the base; and
a fourth pulley, coupled to the base, wherein the third pulley and/or the fourth pulley are disposed at a distal end, wherein the first motor and/or the second motor are disposed at a second end, and wherein the twist pulley is movably disposed to translate within a first movement range between the distal end and the second end.

8. The vibrator device of claim 7, wherein the belt is arranged in an H pattern.

9. The vibrator device of claim 1, wherein translation of the ring the stroke axis causes stroke movement of the housing, and wherein rotation of the ring causes lateral movement of the housing.

10. The vibrator device of claim 1, further comprising:
a communications module configured to communicate with a user device; and
a processor, configured to operate the first motor and the second motor based on instructions received by the communications module from the user device.

11. A vibrator device, comprising:
a housing; and
a two-axis haptics mechanism, disposed within the housing, the two-axis haptics mechanism comprising:
a base, comprising a cylindrical form with form features disposed on an outside of the cylindrical form;
a first ring, coupled to the base, disposed around the base, and configured to rotate around the base in conformance with the form features;
a second ring, coupled to the base, disposed around the base, and configured to rotate around the base in conformance with the form features, wherein:
rotation of the first ring and the second ring in opposite directions causes the base to translate along a stroke axis relative to the first ring and the second ring; and
rotation of both the first ring and the second ring in a same direction causes the base, the first ring, and the second ring to rotate around the stroke axis.

12. The vibrator device of claim 11, wherein the first ring and the second ring are disposed proximate to each other.

13. The vibrator device of claim 12, wherein the first ring and the second ring contact each other.

14. The vibrator device of claim 12, wherein the first ring and the second ring are configured to rotate while being disposed proximate to each other.

15. The vibrator device of claim 11, further comprising:
a first motor, coupled to the first ring and configured to drive the first ring to rotate around the base; and
a second motor, coupled to the second ring and configured to drive the second ring to rotate around the base.

16. The vibrator device of claim 11, wherein the form features are one or more grooves disposed within the cylindrical form.

17. The vibrator device of claim 16, wherein the first ring and the second ring both comprise one or more tongues configured to be disposed within the one or more grooves.

18. The vibrator device of claim 16, wherein the grooves comprise a first helix form disposed on a first side of the cylindrical form and a second helix form disposed on a second side of the cylindrical form.

19. The vibrator device of claim 11, wherein translation of the base along the stroke axis causes stroke movement of the housing, and wherein rotation of the base, the first ring, and the second ring causes lateral movement of the housing.

20. The vibrator device of claim 11, further comprising:
a communications module configured to communicate with a user device; and
a processor, configured to operate the first ring and the second ring based on instructions received by the communications module from the user device.
